(19) United States
(12) Patent Application Publication
(10) Pub. No.: US 2024/0238738 A1
(43) Pub. Date: Jul. 18, 2024

(54) Botanical Resin Extraction Apparatus

(71) Applicant: Tiny Holdings Co, LLC, Arvada, CO (US)

(72) Inventors: Levi Garrett Lanzrath, Lakewood, CO (US); Steven Knabe, Arvada, CO (US)

(21) Appl. No.: 18/412,234

(22) Filed: Jan. 12, 2024

Related U.S. Application Data
(60) Provisional application No. 63/479,899, filed on Jan. 13, 2023.

(51) Int. Cl. B01F 23/53; B01D 11/02; B01F 27/053; B01F 27/13; B01F 35/00; B01F 35/32; B01F 35/45; B01F 35/51; C09F 1/00

(52) U.S. Cl. CPC B01F 23/53; B01D 11/0288; B01F 27/053; B01F 27/13; B01F 35/181; B01F 35/3202; B01F 35/3204; B01F 35/45; B01F 35/51; C09F 1/00

(57) ABSTRACT

Apparatuses and methods are provided for use in the extraction of botanical resins from plant-based source materials. The apparatuses comprise a container operable to hold liquids. The container may be closed using a first lid. The first lid may comprise a center hole through which a whisk may be inserted and locked in place. The whisk is operable to rotate using a rotation mechanism and subsequently stirs the contents of the container. The rotation may be manual or motor driven. After stirring, the first lid is removed and a second lid is attached. The second lid may comprise an integrated mesh filter and a spout so that liquid contents of the container may be easily poured out.

### CROSS-REFERENCE TO RELATED APPLICATIONS

This application claims the benefit of U.S. Provisional Application No. 63/479,899 entitled “Botanical Resin Extraction Device” and filed on Jan. 13, 2023, which is herein incorporated by reference in its entirety.

### BACKGROUND

### Technical Field

Embodiments of the invention relate generally to apparatuses used to extract botanical resins from plant-based source materials.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

Apparatuses and methods are provided for use in the extraction of botanical resins from plant-based source materials. The apparatuses comprise a container operable to hold liquids. The container may be closed using a first lid. The first lid may comprise a center hole through which a whisk may be inserted and locked in place. The whisk is operable to rotate using a rotation mechanism and subsequently stirs the contents of the container. The rotation may be manual or motor driven. After stirring, the first lid is removed and a second lid is attached. The second lid may comprise an integrated mesh filter and a spout so that liquid contents of the container may be easily poured out.

### BRIEF DESCRIPTION OF THE DRAWING FIGURES

Embodiments of the invention are described in detail below with reference to the attached drawing figures, wherein:

FIG. 1 illustrates apparatuses for extracting botanical resins according to some embodiments;

FIG. 2 illustrates whisk designs for use in apparatuses for extracting botanical resins according to some embodiments;

FIG. 3A illustrates a first mixing member design for use in apparatuses for extracting botanical resins according to some embodiments;

FIG. 3B illustrates a second mixing member design for use in apparatuses for extracting botanical resins according to some embodiments;

FIG. 3C illustrates a third mixing member design for use in apparatuses for extracting botanical resins according to some embodiments;

FIG. 3D illustrates a fourth mixing member design for use in apparatuses for extracting botanical resins according to some embodiments;

FIG. 3E illustrates a fifth mixing member design for use in apparatuses for extracting botanical resins according to some embodiments;

FIG. 3F illustrates a sixth mixing member design for use in apparatuses for extracting botanical resins according to some embodiments;

FIG. 3G illustrates a seventh mixing member design for use in apparatuses for extracting botanical resins according to some embodiments;

FIG. 4 illustrates lid designs for use in apparatuses for extracting botanical resins according to some embodiments; and

FIG. 5 describes methods for using the apparatuses.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

It is noted that as used herein and, in the claims, the singular forms “a,” “an,” and “the” include plural referents unless the context clearly dictates otherwise. Thus, for example, reference to “a layer” includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. Where the modifier “about” or “approximately” is used, the stated quantity can vary by up to 10%. Where the modifier “substantially equal to” or “substantially the same” is used, the two quantities may vary from each other by no more than 5%.

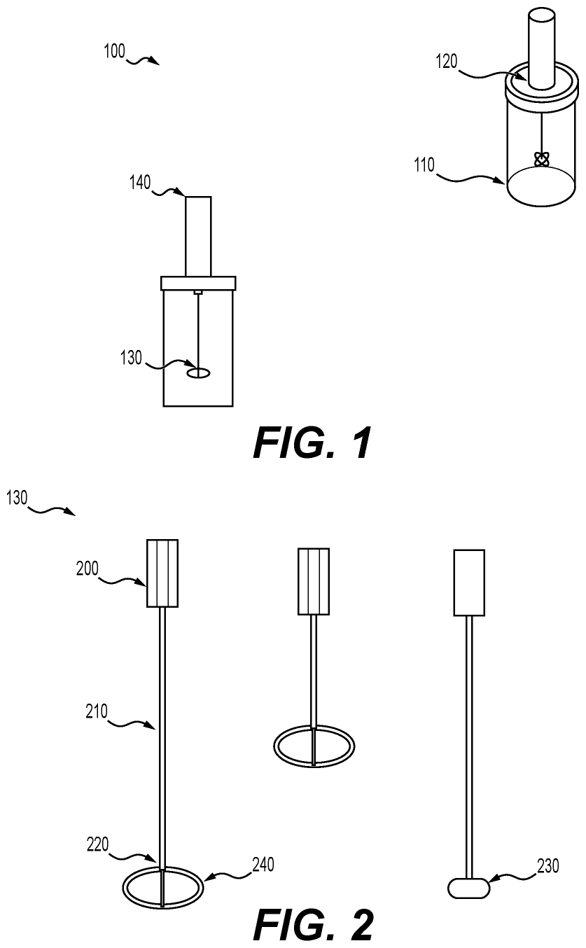

FIG. 1 illustrates apparatuses 100 for extracting botanical resins according to some embodiments. The apparatuses comprise a container 110 suitable for holding a liquid. The container may be formed from glass, plastic, metal, or ceramic. Advantageously, the container is formed from glass. In some embodiments, the container may comprise a commercially available glass jar such as is used in canning and storing of food items. The container may range in size from about 12 ounces to about 128 ounces. In embodiments, the container is about 64 ounces. Advantageously, the container has a “wide mouth” and screw threads at the opening for attaching lids as is known in the art.

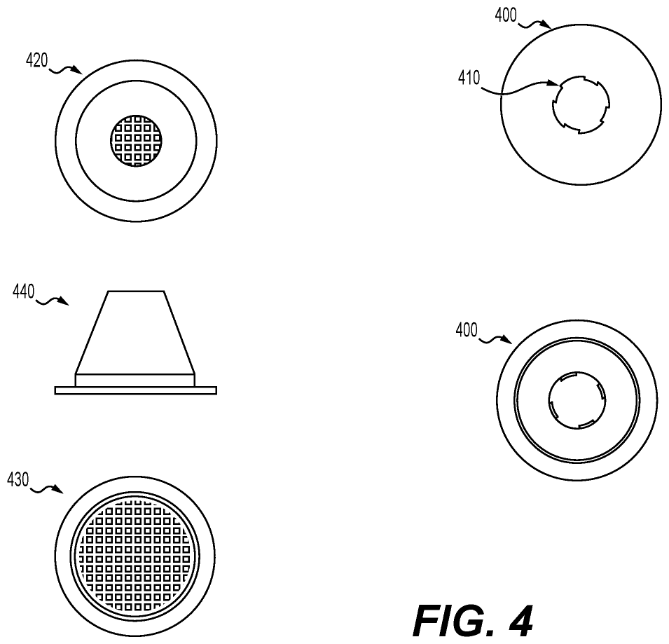

The apparatuses further comprise a first lid 120 operable to close the container. The first lid may be formed from plastic, metal, or ceramic. Advantageously, the first lid comprises screw threads to mate with the screw threads on the container to form a tight seal. The first lid also comprises a center hole through which a whisk 130 (discussed below) can be inserted through the lid and into the container. The center hole may comprise a locking mechanism 410 (see FIG. 4) to lock the whisk 130 in place and to prevent liquids within the container from exiting the hole while the whisk is inserted. The whisk 130 may be rotated using a rotation mechanism 140 while inserted into the container to mix the contents of the container. The rotation mechanism may be manual or may comprise a motor.

FIG. 2 illustrates whisk 130 designs for use in apparatuses for extracting botanical resins according to some embodiments. The whisk may be formed from plastic, metal, or ceramic. The whisk may have a proximal end 200 and a distal end 220 connected by a shaft 210. The proximal end of the whisk is operable to engage with the rotation mechanism 140 discussed with respect to FIG. 1. The shaft of the whisk may be of different lengths to accommodate the depth of the container 110. The distal end of the whisk may comprise a mixing member 230. The mixing member may have a variety of shapes as will be discussed below. In certain embodiments, the mixing member may comprise a simple loop 240 as depicted in FIG. 2. The length of the shaft may be selected such that the mixing member is situated anywhere between near the bottom of the container to near the top of the container. Advantageously, the mixing member is situated near the center of the container.

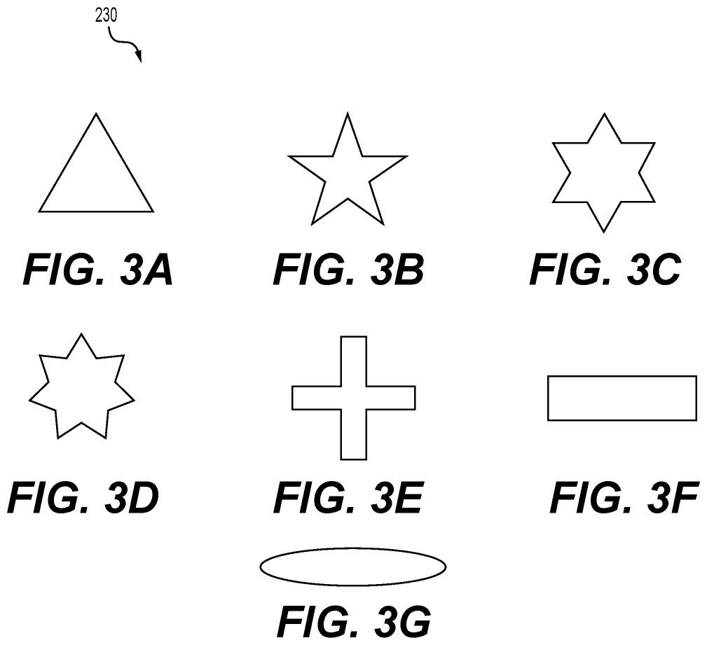

FIGS. 3A-3G illustrates mixing member 230 designs for use in apparatuses for extracting botanical resins according to some embodiments. The mixing members (3A-3G) are attached at the distal end 220 of the whisk and are operable to mix the contents of the container when the whisk is rotated. The mixing member may be formed from plastic, metal, or ceramic. The mixing member may have a variety of shapes. Some examples of mixing member shapes comprise a triangle shape (FIG. 3A), a five-pointed star shape (FIG. 3B), a six-pointed star shape (FIG. 3C), a seven-pointed star shape (FIG. 3D), a cross shape (FIG. 3E), a rectangle shape (FIG. 3F), and an ellipse shape (FIG. 3G), among others. Those skilled in the art will understand that this list of shape examples is not exhaustive and other shapes may be used and still fall within the scope of the invention. As an example, the mixing member may be the simple loop 240 as illustrated in FIG. 2.

FIG. 4 illustrates lid designs for use in apparatuses for extracting botanical resins according to some embodiments. FIG. 4 illustrates a first lid 400 that is operable to close the container. The first lid may be constructed from metal, plastic, or ceramic. As discussed with respect to FIG. 1, advantageously, the container comprises a commercially available glass jar such as is used in canning and storing of food items and the first lid can be easily attached to the container. The first lid may comprise center hole through which a whisk 130 can be inserted through the lid and into the container. The center hole may comprise a locking mechanism 410 to lock the whisk in place and to prevent liquids within the container from exiting the hole while the whisk is inserted.

FIG. 4 illustrates a second lid 420 that is operable to close the container. The second lid may be constructed from metal, plastic, or ceramic. The second lid may comprise an integrated mesh filter 430 operable to prevent solid contents of the container from exiting the container as the liquid within the container is poured out. In embodiments, mesh filter 430 comprises pores of approximately 400 micron diameter. The second lid may comprise an integrated spout 440 operable to assist in the pouring of the liquid out. The second lid may comprise an integrated spout 440 so that liquid contents of the container may be easily poured out.

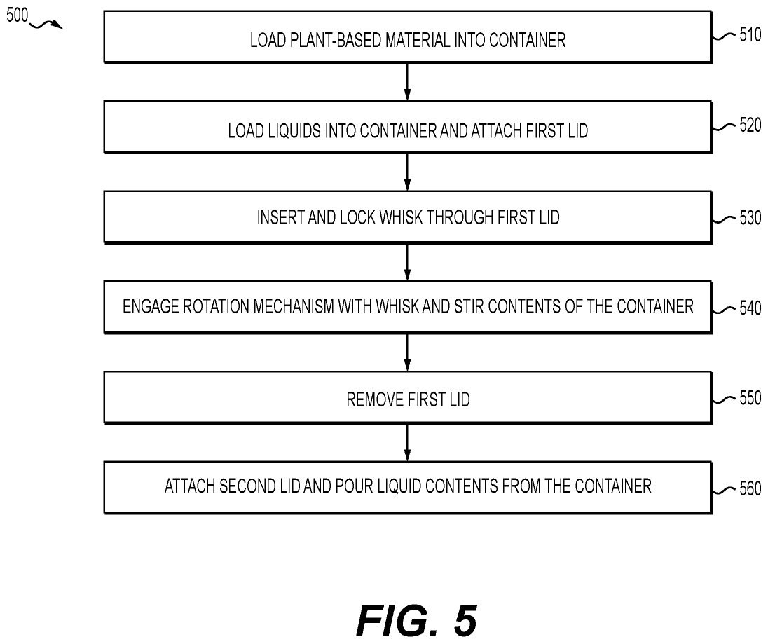

FIG. 5 describes methods 500 for using the apparatuses. In step 510 the plant-based material from which the botanical resins are to be extracted is loaded into the container. In step 520 the liquids used in the extraction process are loaded into the container and the first lid is attached. The liquids may comprise water and/or suitable solvents. In step 530 the whisk is inserted through the center hole of the first lid and locked into place using the locking mechanism discussed above. In step 540 the proximal end of the whisk is engaged with the rotation mechanism (either manual or motor driven) and the contents of the container are stirred according to an extraction process recipe. In step 550 the first lid is removed. In step 560 the second lid is attached, and the liquid contents of the container are poured out of the container.

Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected by Letters Patent includes the following:

1. An apparatus, the apparatus comprising:
a container suitable for holding a liquid;
a first lid operable to close the container;
a whisk, wherein the whisk extends through the first lid and into the container;
wherein the whisk comprises a proximal end and a distal end;
wherein the proximal end of the whisk engages with a rotation mechanism;
wherein the distal end of the whisk comprises a mixing member;
a second lid operable to close the container;
wherein the second lid comprises an integrated mesh filter; and
wherein the second lid comprises a spout for pouring the liquid through the integrated mesh filter and out of the container.

2. The apparatus of claim 1 wherein the container is formed from one of glass, plastic, metal, or ceramic.

3. The apparatus of claim 2 wherein the container is formed from glass.

4. The apparatus of claim 1 wherein the container has a size between about 12 ounces and about 128 ounces.

5. The apparatus of claim 4 wherein the container has a size of about 64 ounces.

6. The apparatus of claim 1 wherein the first lid comprises a locking mechanism for locking the whisk in place.

7. The apparatus of claim 1 wherein the whisk is formed from one of plastic, metal, or ceramic.

8. The apparatus of claim 7 wherein the whisk is formed from metal.

9. The apparatus of claim 1 wherein the rotation mechanism is one of manual or a motor.

10. The apparatus of claim 1 wherein the rotation mechanism is a motor.

11. The apparatus of claim 1 wherein the rotation mechanism is manual.

12. The apparatus of claim 1 wherein the mixing member is formed from one of plastic, metal, or ceramic.

13. The apparatus of claim 1 wherein the mixing member has a shape that is one of a triangle, a five-pointed star, a six-pointed star, a seven-pointed star, a cross, a rectangle, an ellipse, or a loop.

14. The apparatus of claim 13 wherein the mixing member has a shape that is a loop.

15. The apparatus of claim 1 wherein a shaft of the whisk may have different lengths to accommodate a depth of the container.

16. The apparatus of claim 15 wherein the length of the shaft of the whisk positions the mixing member near a bottom of the container.

17. The apparatus of claim 15 wherein the length of the shaft of the whisk positions the mixing member near a top of the container.

18. The apparatus of claim 1 wherein the integrated mesh filter has pores of about 400 microns.

19. A method for extracting resin from plant-based material, the method comprising:
loading plant-based material into a container;
loading liquids used in an extraction process into the container and attaching a first lid to the container;
inserting a whisk through a center hole in the first lid and locking the whisk in place;
engaging a proximal end of the whisk with a rotation mechanism;
stirring the plant-based material and the liquids held within the container according to an extraction recipe;
removing the first lid;
attaching a second lid to the container, wherein the second lid comprises an integrated mesh filter and a spout; and
pouring the liquid contents of the container out of the container through the integrated mesh filer.

20. The method of claim 18 wherein the liquids used in the extraction process are water, solvents, or a mixture of water and solvents.
